(19) United States
(12) Patent Application Publication
(10) Pub. No.: US 2021/0210070 A1
(43) Pub. Date: Jul. 8, 2021

(54) SKILL SERVICE UPDATING METHOD, ELECTRONIC DEVICE AND READABLE STORAGE MEDIUM

(71) Applicant: BAIDU ONLINE NETWORK TECHNOLOGY (BEIJING) CO., LTD, Beijing (CN)

(72) Inventors: Hongwei CAO, Beijing (CN); Xiao ZHOU, Beijing (CN); Jiachuan JIAO, Beijing (CN)

(73) Assignee: BAIDU ONLINE NETWORK TECHNOLOGY (BEIJING) CO., LTD, Beijing (CN)

(21) Appl. No.: 17/018,609

(22) Filed: Sep. 11, 2020

(30) Foreign Application Priority Data
Jan. 8, 2020 (CN) 2020100169227

(51) Int. Cl. G10L 15/06; G10L 15/22; G06N 20/00

(52) U.S. Cl. CPC G10L 15/063; G10L 15/22; G10L 2015/0635; G10L 2015/223; G06N 20/00

(57) ABSTRACT

A skill service updating method, electronic device and readable storage medium are disclosed. According to some embodiments, the supplementary interaction information of the skill service is obtained according to the user interaction log of the skill service based on the user interaction model, where the user interaction model is created according to initial interaction information of the skill service provided by the developer; then the supplementary interaction information of the skill service is output, so that it is possible to, in response to an operation of the developer based on the supplementary interaction information of the skill service, perform updating processing on the user interaction model with the supplementary interaction information of the skill service

### CROSS-REFERENCE TO RELATED APPLICATIONS

The present application claims the priority and benefit of Chinese Patent Application No. 2020100169227, filed on Jan. 8, 2020. The disclosure of the above application is incorporated herein by reference in its entirety.

### TECHNICAL FIELD

The present disclosure relates to the technical field of computers, particularly to artificial intelligence technologies, and more particularly to a skill service updating method, apparatus, electronic device and readable storage medium.

### BACKGROUND

The service logic of an intelligent device such as a smart household appliance or an intelligent terminal device based on a dialog-type AI (artificial intelligence) system is generally implemented in a skill service manner for a certain specific topic. The so-called skill service is similar to an APP (application) service, and may complete one or more specific functions via conversations, e.g., query for weather forecast, query for flights, order a meal, etc. Each skill service may include one or more intents. During conversations, the corresponding intent is obtained by recognizing the request.

A developer of a skill service may create a user interaction model corresponding to the skill service based on an interactive speech open platform provided by large companies, thereby adding the skill service to the intelligent device and providing it as the service logic of the intelligent device to the user for use. Typically, to improve the user experience, the developer may further use a log system created by himself to analyze the user interaction of the skill service and thereby update the skill service provided by the intelligent device.

However, the inventors of the present disclosure found that, the related manner of updating the skill service requires a long operation duration and is prone to errors, thereby causing reduction of the developing efficiency and reliability of the skill service provided by the intelligent device.

### SUMMARY

A plurality of aspects of the present disclosure provide a skill service updating method, apparatus, electronic device arid readable storage medium, to improve the developing efficiency and reliability of the skill service provided by the intelligent device.

In an aspect of the present disclosure, the present disclosure provides a skill service, the method includes: obtaining supplementary interaction information of a skill service according to a user interaction log of the skill service based on a user interaction model, and the user interaction model is created according to initial interaction information of the skill service provided by the developer; outputting the supplementary interaction information of the skill service; and performing updating processing on the user interaction model with the supplementary interaction information of the skill service, in response to an operation of the developer based on the supplementary interaction information of the skill service.

According to some embodiments, the obtaining supplementary interaction information of a skill service according to a user interaction log of the skill service based on a user interaction model includes: performing analysis processing on the user interaction log of the skill service to obtain structured data which includes a name of the skill service, request information and intent information; and taking the structured data different from the initial interaction information of the skill service, as the supplementary interaction information of the skill service, according to the initial interaction information of the skill service.

According to some embodiments, the request information includes a speech recognition result of the speech information provided by the user and/or text information provided by the user.

According to some embodiments, the performing updating processing on the user interaction model with the supplementary interaction information of the skill service includes: performing directly updating processing on the user interaction model with the supplementary interaction information of the skill service; or performing, editing processing on the supplementary interaction information of the skill service to obtain editing interaction information of the skill service; and performing the updating processing on the user interaction model with the editing interaction information.

According to some embodiments, the performing updating processing on the user interaction model includes: generating an auxiliary interaction model of the skill service so that the user interaction model and the auxiliary interaction model are used to provide the skill service to the user; or generating a new user interaction model so that the new user interaction model is used to provide the skill service to the user.

In another aspect of the present disclosure, there is provided a skill service updating apparatus which includes: an analysis unit configured to obtain supplementary interaction information of a skill service according to a user interaction log of the skill service based on a user interaction model, where the user interaction model is created according to initial interaction information of the skill service provided by the developer; an output unit configured to output the supplementary interaction information of the skill service; an updating unit configured to, perform updating processing on the user interaction model with the supplementary interaction information of the skill service, in response to an operation of the developer based on the supplementary interaction information of the skill service.

According to some embodiments, the analysis unit is specifically configured to: perform analysis processing on the user interaction log of the skill service to obtain structured data which includes a name of the skill service, request information and intent information; and take the structured data different from the initial interaction information of the skill service, as the supplementary interaction information of the skill service according to the initial interaction information of the skill service.

According to some embodiments, the request information includes a speech recognition result of the speech information provided by the user and/or text information provided by the user.

According to some embodiments, the updating unit is specifically configured to perform directly updating processing on the user interaction model with the supplementary interaction information of the skill service; or perform editing processing on the supplementary interaction information of the skill service to obtain editing interaction information of the skill service; and perform the updating processing on the user interaction model with the editing interaction information.

According to some embodiments, the updating unit is specifically configured to: generate an auxiliary interaction model of the skill service so that the user interaction model and the auxiliary interaction model are used to provide the skill service to the user; or generate a new user interaction model so that the new user interaction model is used to provide the skill service to the user.

In a further aspect of the present disclosure, the present disclosure provides an electronic device, which includes: at least one processor; and a storage communicatively connected with the at least one processor; where, the storage stores instructions executable by the at least one processor, and the instructions are executed by the at least one processor to enable the at least one processor to perform the method described above.

In a further aspect of the present disclosure, the present disclosure provides a non-transitory computer-readable storage medium storing computer instructions therein, where the computer instructions are used to cause the computer to perform the method described above.

According to technical solutions of the present disclosure, the supplementary interaction information of the skill service is obtained according to the user interaction log of the skill service based on the user interaction model, and the user interaction model is created according to initial interaction information of the skill service provided by the developer; then the supplementary interaction information of the skill service is output, so that it is possible to, in response to an operation of the developer based on the supplementary interaction information of the skill service, perform updating processing on the user interaction model with the supplementary interaction information of the skill service. The developer himself may implement the update of the skill service without analyzing the user interaction of the skill service, thereby improving the developing efficiency and reliability of the skill service provided by the intelligent device.

In addition, according to the technical solution of the present disclosure, the supplementary interaction information of the skill service is obtained through the user interaction log based on the skill service, so that the user interaction model of the skill service may be enhanced for the reliable feedback, the user interaction model of the skill service may be supplemented for the unreliable feedback, and the reliability of the skill service provided by the intelligent device may be further improved.

In addition, according to the technical solution of the present disclosure, it is possible to, by outputting the supplementary interaction information of the skill service, actively remind the developer that the service provided by the developer further has additional interaction information to achieve more perfect service and thereby further improve the developing efficiency of the skill service provided by the intelligent device.

In addition, the technical solutions according to the present disclosure may be employed to effectively improve the user experience.

Other effects of the above aspects or possible implementations will be described hereunder in conjunction with various embodiments.

### BRIEF DESCRIPTION OF THE DRAWINGS

To describe technical solutions of embodiments of the present disclosure more clearly, figures to be used in the embodiments or in depictions regarding the prior art will be described briefly. Obviously, the figures described below are only some embodiments of the present disclosure. Those having ordinary skill in the art appreciate that other figures may be obtained from these figures without making inventive efforts. The figures are only intended to facilitate better understanding of the solution and not construed as limiting the present disclosure. In the figures,

FIG. 1 illustrates a flow chart of a skill service according to some embodiments of the present disclosure;

FIG. 2 illustrates a structural schematic diagram of a skill service according to some embodiments of the present disclosure; and

FIG. 3 illustrates a schematic diagram of an electronic device for implementing the skill service updating method according to some embodiments of the present disclosure.

### DETAILED DESCRIPTION

Exemplary embodiments of the present disclosure are described below with reference to the accompanying drawings, include various details of the embodiments of the present disclosure to facilitate understanding, and should be considered as merely exemplary. Therefore, those having ordinary skill in the art should recognize that various changes and modifications may be made to the embodiments described herein without departing from the scope and spirit of the application. Also, for the sake of clarity and conciseness, depictions of well-known functions and structures are omitted in the following description.

Obviously, the described embodiments are partial embodiments of the present disclosure, not all embodiments. Based on embodiments in the, present disclosure, all other embodiments obtained by those having ordinary skill in the art without making inventive efforts all fall within the protection scope of the present disclosure.

It is to be appreciated that the terminals involved in the embodiments of the present disclosure include but are not limited to a mobile phone, a Personal Digital Assistant (PDA), a wireless handheld device, a tablet computer, a Personal Computer (PC), an MP3 player, an MP4 player, and a wearable device (e.g., a pair of smart glasses, a smart watch, or a smart bracelet).

In addition, the term “and/or” used in the text is only an association relationship depicting associated objects and represents that three relations might exist, for example, A and/or B may represent three cases, namely, A exists individually, both A and B coexist, and B exists individually. In addition, the symbol “/” in the text generally indicates associated objects before and after the symbol are in an “or” relationship,

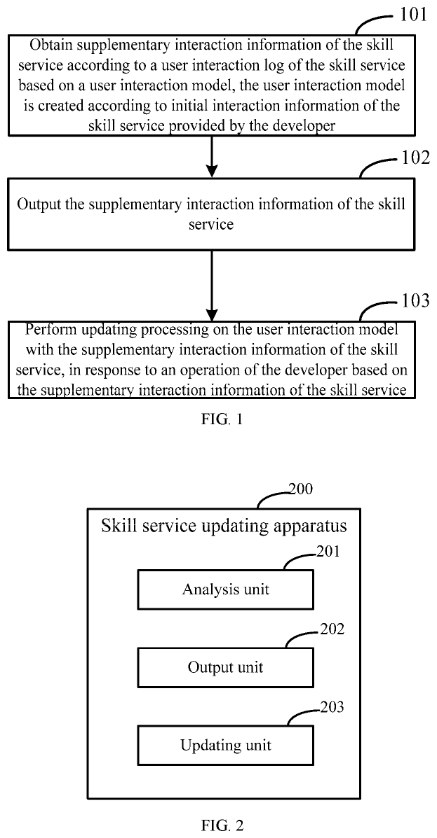

FIG. 1 illustrates a flow chart of a skill service updating method according to some embodiments of the present disclosure. With reference to FIG. 1, the method may include:

101: obtaining supplementary interaction information of a skill service according to a user interaction log of the skill service based on a user interaction model, and the user interaction model is created according to initial interaction information of the skill service provided by the developer.

102: outputting the supplementary interaction information of the skill service.

103: performing updating processing on the user interaction model with the supplementary interaction information of the skill service, in response to an operation of the developer based on the supplementary interaction information of the skill service.

It is to be appreciated that subjects for executing 101-103 may partially or totally be an application located in a local terminal, or a function unit such as a plug-in or Software Development Kit (SDK) located in an application of the local terminal, or a processing engine located in a network-side server, or a distributed type system located on the network side, for example, a processing engine or distributed system in the network-side interactive speech open platform. This is not particularly limited in the embodiments.

It is to be understood that, in some embodiments, the application is a native application (nativeAPP) installed on the terminal, or a web program (webApp) of a browser on the terminal. This is not particularly limited in the embodiments.

As such, the supplementary interaction information of the skill service is obtained according to the user interaction log of the skill service based on the user interaction model, and the user interaction model is created according to initial interaction information of the skill service provided by the developer; then the supplementary interaction information of the skill service is output, so that it is possible to, in response to an operation of the developer based on the supplementary interaction information of the skill service, perform updating processing on the user interaction model with the supplementary interaction information of the skill service. The developer himself may implement the update of the skill service without analyzing the user interaction of the skill service, thereby improving the developing efficiency and reliability of the skill service provided by the intelligent device.

Typically, the developer may add one or more services provided by it to the intelligent device based on an AI system, and provide the one or more services as the service logic of the intelligent device to the user for use. Generally speaking, the developer of the skill service may provide the initial interaction information of the skill service, and create the user interaction model corresponding to the skill service with the provided initial interaction information of the skill service, based on the interactive speech open platform provided by large companies, for example, a DBP (DuerOS Bot Platform), thereby adding the skill service into the intelligent device and providing it as the service logic of the intelligent device to the user for use. Each set of initial interaction information may include but not limited to a name of the skill service, request information and intent information. This is not particularly limited in the present disclosure.

A method for creating the user interaction model corresponding to the skill service based on the interactive speech open platform provided by large companies, for example, a DBP (DuerOS Bot Platform) may employ various methods in the prior art. After the user interaction model is already created, the user may use the skill service provided by the intelligent device.

Specifically, after receiving the speech information provided by the user, the intelligent device may send the speech information to the DBP. After receiving the speech information, the DBP perform speech recognition processing on the speech information to obtain a speech recognition result. The DBP, according to the speech recognition result, determines the user interaction model of the corresponding skill service and a service end device of the skill service. Then, the DBP may use the user interaction model to convert the recognition result of the speech information into corresponding intent information, for example, intent + slot, and sends the intent information to the service end device of the skill service. The service end device completes feedback with respect to the intent information and sends acknowledgement information of the feedback to the intelligent device through the DBP. The intelligent device performs output processing such as speech broadcast or screen display for the acknowledgement information of the feedback.

It is to be understood that in addition to speech information, the user might provide text information. After the DBP receives the text information provided by the user through the intelligent device, the DBP may determine the user interaction model of the corresponding skill service and the service end device of the skill service directly according to the text information. Then, the DBP may use the user interaction model to convert the text information into corresponding intent information, for example, intent+slot, and send the intent information to the service end device of the skill service. The service end device completes feedback with respect to the intent information and sends acknowledgement information of the feedback to the intelligent device through the DBP. The intelligent device performs output processing such as speech broadcast or screen display for the acknowledgement information of the feedback.

While the DBP uses the user interaction model to convert the text information into corresponding intent information, if the conversion is successful, the DBP will send the converted intent information to the service end device of the skill service; if the conversion is unsuccessful, the DBP will send a preset instruction such as None to the service end device of the skill service to indicate that no suitable intent information is matched.

While using the skill service provided by the intelligent device, the user may further record the user interactions using a log system to generate a user interaction log of the skill service. Each piece of interaction log may include but not limited to a log ID, a name of the skill service, request information, intent information and acknowledgement information of the feedback. This is not particularly limited in the present disclosure. The acknowledgement information of the feedback may include a positive feedback acknowledgement capable of indicating a reliable feedback and a negative feedback acknowledgment capable of indicating an unreliable feedback.

The request information may include but not limited to a speech recognition result of the speech information provided by the user and/or text information provided by the user, for example. “How is the weather today?”. This is not particularly limited in the embodiments.

Optionally, in a possible implementation of the embodiment, at 101, it is specifically possible to perform analysis processing on the user interaction log of the skill service to obtain structured data which includes the name of the skill service, the request information and intent information. Then, it is possible to, according to the initial interaction information of the skill service, take the structured data different from the initial interaction information of the skill service, as the supplementary interaction information of the skill service.

Specifically, the log system may be accessed periodically to obtain the user interaction log of the skill service. Then, deep learning may be performed on the user interaction log, particularly, analysis processing may be performed on the user logs having negative feedback acknowledgements, e.g., a log ID (ID1), a name of the skill service (Zhixin Weather), request information (Do I need to wear a down coat today?), intent information (None) and acknowledgement information of the feedback (Sorry, I did not get it, please say it again), to obtain the structured data.

In this way, it is not only possible to obtain more reliable request information and intent information based on the obtained user interaction logs of the skill services, thereby enhancing the user interaction model of the skill services for the reliable feedback, but also possible to obtain reliable request information and intent information based on the obtained user interaction logs of the skill services, supplement the user interaction model of the skill services for the unreliable feedback, and further improve the reliability of the skill services provided by the intelligent device.

Optionally, in some embodiments, at 102, the supplementary interaction information of the skill service may specifically output in various manners. As such, it is possible to, by outputting the supplementary interaction information of the skill service, actively recommend and remind the developer that there is additional interaction information that may improve the service provided by the developer, and thereby further improve the developing efficiency of the skill service provided by the intelligent device.

In some embodiments, the supplementary interaction information of the skill service may be specifically output to the developer in an instant communication manner such as an instant message or E-mail

In some embodiments, the supplementary interaction information of the skill service may be specifically output to the developer by employing a system message.

Optionally, in some embodiments, before 103, an operation of the developer based on the supplementary interaction information of the skill service may be further obtained. The operation may include but not limited to an operation gesture. The operation gesture may include but not limited to at least one of the following operation gestures: an operation gesture of the developer for an operation control corresponding to the supplementary interaction information of the skill service; a suspension operation gesture of the developer above the supplementary interaction information of the skill service; a contacting operation gesture of the developer on the supplementary interaction information of the skill service; and a movement tendency of the developer moving the terminal based on the supplementary interaction information of the skill service.

The so-called operation gesture of the developer for an operation control corresponding to the supplementary interaction information of the skill service may mean that the developer operates, for example click-operates, a confirm operation control corresponding to the supplementary interaction information of the skill service displayed by a display device of the terminal. For the so-called operation control, the developer may interact with the operation control to input or operate data thereto and may consist of one or more page elements. The click-operation may be a trigger operation performed by the developer using an external input device such as a mouse or keyboard to control a cursor, or a touch operation performed by the developer using a linger or a touch control input device such as an input pen. This is not particularly limited in the embodiments.

For example, the developer may specifically click-operate on a confirm operation control corresponding to the supplementary interaction information of the skill service. After obtaining the developer's click-operation gesture of the confirm operation control corresponding to the supplementary interaction information of the skill service, updating processing may be performed on the user interaction model with the supplementary interaction information of the skill service.

The so-called suspension operation gesture of the developer above the supplementary interaction information of the skill service may refer to a suspended sliding trajectory of the developer above the supplementary interaction information of the skill service displayed by the display device of the terminal within an image acquisition range of an image sensor of the terminal used. The image sensor may be a Charge Coupled Device (CCD) sensor or a Complementary Metal-Oxide Semiconductor (CMOS) sensor. This is not particularly limited in the embodiments. The suspended sliding trajectory may include but not limited to a straight line or a curve of any shape composed of several stay points corresponding to several continuous sliding events. This is not particularly limited in the embodiments.

The so-called contacting operation gesture of the developer on the supplementary interaction information of the skill service may refer to the developer's contact sliding trajectory on the supplementary interaction information of the skill service displayed by the display device of the terminal used. Typically, the terminals may be classified into two types according to whether the display device has a touch-enabled property: one type is touch control terminals, and the other type is non-touch-control terminals. Specifically, the developer's contact sliding trajectory on the supplementary interaction information of the skill service display by a touch screen of the touch-enabled terminal. The contact sliding trajectory may include but not limited to a straight line or a curve of any shape composed of several touch points corresponding to several continuous sliding events. This is not particularly limited in the embodiments. Specifically, the contacting operation gesture is the developer's click-operation gesture on any area on the supplementary interaction information of the skill service, or may be the developer's long-press operation gesture on any area on the supplementary interaction information of the skill service, or may be the developer's sliding operation gesture on any area on the supplementary interaction information of the skill service. This is not particularly limited in the embodiments.

For example, the developer may specifically perform a double-tap operation on any area on the supplementary interaction information of the skill service, After the developer's double-tap operation gesture on any area on the supplementary interaction information of the skill service is obtained, content information of the reply message may be directly sent to the first user.

The so-called movement tendency of the developer moving the terminal based on the supplementary interaction information of the skill service may refers to a movement trajectory of the developer who hand-holds the terminal whose display device displays the supplementary interaction information of the skill service and who causes the terminal to move, e.g., shake or flip.

In some embodiments, a sensor device may be specifically used to detect the developer's operation gesture based on the supplementary interaction information of the skill service. Specifically, the sensor device may include but not limited to at least one of a gravity sensor, an acceleration sensor, a pressure sensor, an infrared sensor, a distance sensor and an image sensor. This is not particularly limited in the embodiments.

The distance sensor may be an ultrasonic distance sensor, or an infrared distance sensor, or a laser distance sensor or a microwave distance sensor, which is not particularly limited in the embodiments. These distance sensors all are mature techniques in the prior art. For particulars, please refer to relevant content in the prior art, which will not be detailed here.

The image sensor may be a Charge Coupled Device (CCD) sensor or a Complementary Metal-Oxide Semiconductor (CMOS) sensor. This is not particularly limited in the embodiments.

In some embodiments, the detecting the developer's operation gesture based on the supplementary interaction information of the skill service may specifically include detecting a starting point, a finishing point and a trajectory formed by points from the starting points to the finishing point of the developer's operation gesture based on the supplementary interaction information of the skill service, or further detecting radian data corresponding to the trajectory.

To achieve the above function, optionally, in some embodiments, before the operation of the developer based on the supplementary interaction information of the skill service is obtained, a designated operation may fluffier be preset. Only when the obtained operation satisfies the preset designated operation may the step of using the supplementary interaction information of the skill service to perform updating processing on the user interaction model be executed.

An example is taken in which the obtained operation includes the operation gesture. After the developer's operation gesture based on the supplementary interaction information of the skill service is obtained, the operation gesture may be compared with the preset designated gesture. Only when the obtained operation gesture satisfies the preset designated gesture may the step of using the supplementary interaction information of the skill service to perform updating processing on the user interaction model be executed.

Specifically, data of the designated gesture may be stored in a storage device of the terminal.

In some embodiments, the storage device of the terminal may be a slow-speed storage device, and may specifically be a hard drive of a computer system, or a non-running storage, namely, a physical storage of a mobile phone, for example a Read-Only Memory (ROM) and a memory card. This is not particularly limited in the embodiments.

In some embodiments, the storage device of the terminal may be a fast-speed storage device, and may specifically be a memory of a computer system, or a running memory, namely, a system memory of a mobile phone, for example, a Random Access Memory (RAM). This is not particularly limited in the embodiments.

Optionally, in some embodiments, in step 103, an operation in response to the operation of the developer based on the supplementary interaction information of the skill service, may specifically include performing updating processing on the user interaction model in various manners with the supplementary interaction information of the skill service.

In some embodiments, the updating processing may be performed directly on the user interaction model with the supplementary interaction information of the skill service.

In some embodiments, it is possible to perform editing processing on the supplementary interaction information of the skill service according to the developer's editing operation, to obtain editing interaction information of the skill service. The editing processing may include but not limited to at least one of adding processing, modifying processing and deletion processing. This is not particularly limited in the embodiments. For example, the intent information in the output supplementary interaction information is modified to obtain more precise intent information resulting from the developer's professional modification. Then, the editing interaction information may be used to perform updating processing on the user interaction model.

Optionally, in a possible implementation of the embodiments, at 103, the updating processing may be performed on the user interaction model in various manners.

In some embodiments, it is specifically possible to generate an auxiliary interaction model of the skill service with the supplementary interaction information or the editing interaction information obtained by performing editing processing according to the supplementary interaction information, so that the user interaction model and the auxiliary interaction model are used to provide the skill service to the user.

For example, the supplementary interaction information or the editing interaction information obtained by performing editing processing according to the supplementary interaction information are taken as training data. The training data is used to create the auxiliary interaction model of the skill service.

Furthermore, the code of the user interaction model may be further improved according to the auxiliary interaction model.

In some embodiments, it is specifically possible to generate a new user interaction model with the supplementary interaction information or the editing interaction information obtained by performing editing processing according to the supplementary interaction information, so that the new user interaction model is used to provide the skill service to the user.

For example, the supplementary interaction information or the editing interaction information obtained by performing editing processing according to the supplementary interaction information are taken as training data. The training data is used to further train the user interaction model to generate the new user interaction model.

As such, the supplementary interaction information of the skill service is obtained through the user interaction log based on the skill service, so that the user interaction model of the skill service may be enhanced for the reliable feedback, the user interaction model of the skill service may be supplemented for the unreliable feedback, and the user's degree of satisfaction for the skill service of the intelligent device may be enhanced effectively.

In the embodiments, the supplementary interaction information of the skill service is obtained according to the user interaction log of the skill service based on the user interaction model, and the user interaction model is created according to initial interaction information of the skill service provided by the developer; then the supplementary interaction information of the skill service is output, so that it is possible to, in response to an operation of the developer based on the supplementary interaction information of the skill service, perform updating processing for the user interaction model by using the supplementary interaction information of the skill service. The developer himself may implement the update of the skill service without analyzing the user interaction of the skill service, thereby improving the developing efficiency and reliability of the skill service provided by the intelligent device.

In addition, according to the technical solution of the present disclosure, the supplementary interaction information of the skill service is obtained through the user interaction log based on the skill service, so that the user interaction model of the skill service may be enhanced for the reliable feedback, the user interaction model of the skill service may be supplemented for the unreliable feedback, and the reliability of the skill service provided by the intelligent device may be further improved.

In addition, according to the technical solution of the present disclosure, it is possible to, by outputting the supplementary interaction information of the skill service, actively remind the developer that the service provided by the developer further has additional interaction information to achieve more perfect service and thereby further improve the developing efficiency of the skill service provided by the intelligent device.

In addition, the technical solution according to the present disclosure may be employed to effectively improve the user experience.

It is to be noted that, for ease of description, the aforesaid method embodiments are all described as a combination of a series of actions, but those skilled in the art should appreciate that the present disclosure is not limited to the described order of actions because some steps may be performed in other orders or simultaneously according to the present disclosure. Secondly, those skilled in the art should appreciate the embodiments described in the description are merely specific embodiments, and the involved actions and modules are not necessarily requisite for the present disclosure.

In the above embodiments, different emphasis is placed on respective embodiments, and reference may be made to related depictions in other embodiments for portions not detailed in a certain embodiment.

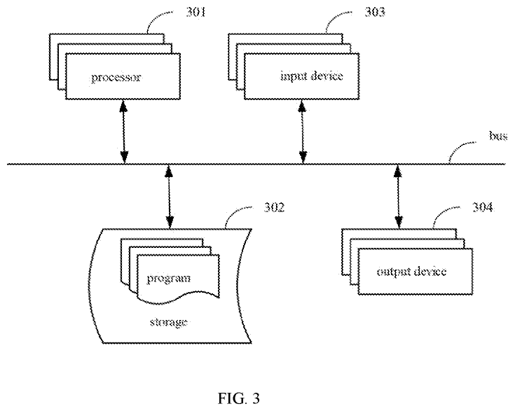

FIG. 2 illustrates a structural schematic diagram of a skill service updating apparatus according to some embodiments of the present disclosure. With reference to FIG. 2, the skill service updating apparatus 200 of the embodiments may include an analysis unit 201, an output unit 202 and an updating unit 203. The analysis unit 201 is configured to obtain supplementary interaction information of a skill service according to a user interaction log of the skill service based on a user interaction model, and the user interaction model is created according to initial interaction information of the skill service provided by the developer; the output unit 202 is configured to output the supplementary interaction information of the skill service; the updating unit 203 is configured to, in response to an operation of the developer based on the supplementary interaction information of the skill service, perform updating processing on the user interaction model with the supplementary interaction information of the skill service.

It is to be appreciated that subjects for executing the skill service updating apparatus according to some embodiments may partially or totally be an application located in a local terminal, or a function unit such as a plug-in or Software Development Kit (SDK) located in an application of the local terminal, or a processing engine located in a network-side server, or a distributed type system located on the network side, for example, a processing engine or distributed system in the network-side interactive speech open platform. This is not particularly limited in the embodiments.

It may be understood that the application may be a native application (nativeAPP) installed on the terminal, or a web program (webApp) of a browser on the terminal. This is not particularly limited in the present embodiment.

Optionally, in some embodiments, the analysis unit 201 is specifically configured to perform analysis processing on the user interaction log of the skill service to obtain structured data which includes a name of the skill service, request information and intent information; and take the structured data different from the initial interaction information of the skill service, as the supplementary interaction information of the skill service, according to the initial interaction information of the skill service.

The request information may include but not limited to a speech recognition result of the speech information provided by the user and/or text information provided by the user. This is not particularly limited in the embodiments.

Optionally, in some embodiments, the updating unit 203 is specifically configured to perform directly updating processing on the user interaction model with the supplementary interaction information of the skill service; or perform editing processing on the supplementary interaction information of the skill service to obtain editing interaction information of the skill service; perform the updating processing on the user interaction model with the editing interaction information.

Optionally, in some embodiments, the updating unit 203 is specifically configured to generate an auxiliary interaction model of the skill service so that the user interaction model and the auxiliary interaction model are used to provide the skill service to the user; or generate a new user interaction model so that the new user interaction model is used to provide the skill service to the user.

It is to be appreciated that the method in the embodiments corresponding to FIG. 1 may be implemented by the skill service updating apparatus in these embodiments. For particulars, please refer to relevant content in the embodiments corresponding to FIG. 1, which will not be detailed here.

In the embodiments, the analysis unit obtains the supplementary interaction information of the skill service according to the user interaction log of the skill service based on the user interaction model, and the user interaction model is created according to initial interaction information of the skill service provided by the developer; then the output unit outputs the supplementary interaction information of the skill service, so that the updating unit may, in response to an operation of the developer based on the supplementary interaction information of the skill service, perform updating processing on the user interaction model with the supplementary interaction information of the skill service. The developer himself may implement the update of the skill service without analyzing the user interaction of the skill service, thereby improving the developing efficiency and reliability of the skill service provided by the intelligent device.

In addition, according to the technical solution of the present disclosure, the supplementary interaction information of the skill service is obtained through the user interaction log based on the skill service, so that the user interaction model of the skill service may be enhanced for the reliable feedback, the user interaction model of the skill service may be supplemented for the unreliable feedback, and the reliability of the skill service provided by the intelligent device may be further improved.

In addition, according to the technical solution of the present disclosure, it is possible to, by outputting the supplementary interaction information of the skill service, actively remind the developer that the service provided by the developer further has additional interaction information to achieve more perfect service and thereby further improve the developing efficiency of the skill service provided by the intelligent device.

In addition, the technical solution according to the present disclosure may be employed to effectively improve the user experience.

According to some embodiments of the present disclosure, the present disclosure further provides an electronic device and a non-transitory computer readable storage medium in which computer instructions are stored.

FIG. 3 illustrates a block diagram of an electronic device for the skill service updating method according to embodiments of the present disclosure. The electronic device is intended to represent various forms of digital computers, such as laptops, desktops, workstations, personal digital assistants, servers, blade servers, mainframes, and other appropriate computers. The electronic device is further intended to represent various forms of mobile devices, such as personal digital assistants, cellular telephones, smartphones, wearable devices and other similar computing devices. The components shown here, their connections and relationships, and their functions, are meant to be exemplary only, and are not meant to limit implementations of the disclosure described and/or claimed in the text here.

As shown in FIG. 3, the electronic device includes: one or more processors 301, a storage 302, and interfaces connected to components and including a high-speed interface and a low speed interface. Each of the components arc interconnected using various busses, and may be mounted on a common motherboard or in other manners as appropriate. The processor may process instructions for execution within the electronic device, including instructions stored in the storage or on the storage device to display graphical information for a GUI on an external input/output device, such as a display device coupled to the interface. In other implementations, multiple processors and/or multiple buses may be used, as appropriate, along with multiple memories and types of memory. Also, multiple electronic devices may be connected, with each device providing portions of the necessary operations (e.g., as a server bank, a group of blade servers, or a multi-processor system). One processor 301 is taken as an example in FIG. 3.

The storage 302 is a non-transitory computer-readable storage medium provided by the present disclosure. Wherein, the storage stores instructions executable by at least one processor, so that the at least one processor executes the Skill service updating method provided by the present disclosure. The non-transitory computer-readable storage medium of the present disclosure stores computer instructions, which are used to cause a computer to execute the skill service updating method according to the present disclosure.

The storage 302 is a non-transitory computer-readable storage medium and may be used to store non-transitory software programs, non-transitory computer executable programs and modules, such as program instructions/modules corresponding to the skill service updating method in embodiments of the present disclosure (e.g., the analysis unit 201, the output unit 202 and the updating unit 203 shown in FIG. 2). The processor 301 executes various functional applications and data processing of the server, i.e., implements the skill service updating method in the above method embodiment, by running the non-transitory software programs, instructions and units stored in the storage 302.

The storage 302 may include a storage program region and a storage data region, wherein the storage program region may store an operating system and an application program needed by at least one function; the storage data region may store data created according to the use of the electronic device for implementing the skill service updating method according to the embodiment of the present disclosure. In addition, the storage 302 may include a high-speed random access memory, and may also include a non-transitory memory, such as at least one magnetic disk storage device, a flash memory device, or other non-transitory solid-state storage device. In some embodiments, the storage 302 may optionally include a storage remotely arranged relative to the processor 301, and these remote memories may he connected to the electronic device for implementing the skill service updating method according to embodiments of the present disclosure through a network. Examples of the above network include, but are not limited to, the Internet, an intranet, a local area network, a mobile communication network, and combinations thereof.

The electronic device for implementing the skill service updating method may further include an input device 303 and an output device 304. The processor 301, the storage 302, the input device 303 and the output device 304 may be connected through a bus or in other manners. In FIG. 3, the connection through the bus is taken as an example.

The input device 303 may receive inputted numeric or character information and generate key signal inputs related to user settings and function control of the electronic device for implementing the skill service updating method according to the embodiment of the present disclosure, and may be an input device such as a touch screen, keypad, mouse, trackpad, touchpad, pointing stick, one or more mouse buttons, trackball and joystick. The output device 304 may include a display device, an auxiliary lighting device (e.g., an LED), a haptic feedback device (for example, a vibration motor), etc. The display device may include but not limited to a Liquid Crystal Display (LCD), a Light Emitting Diode (LED) display, and a plasma display. In some embodiments, the display device may be a touch screen.

Various implementations of the systems and techniques described here may be realized in digital electronic circuitry, integrated circuitry, specially designed ASICs (Application Specific integrated Circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to send data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the terms “machine-readable medium” and “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The systems and techniques described here may be implemented in a computing system that includes a back end component (e.g., as a data server), or that includes a middleware component (e.g., an application server), or that includes a front end component (e.g., a client computer having a graphical user interface or a Web browser through which a user may interact with an implementation of the systems and techniques described here), or any combination of such back end, middleware, or front end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

According to technical solutions of the present disclosure, the supplementary interaction information of the skill service is obtained according to the user interaction log of the skill service based on the user interaction model, the user interaction model being created according to initial interaction information of the skill service provided by the developer; then the supplementary interaction information of the skill service is output, so that it is possible to, in response to the developer's operation based on the supplementary interaction information of the skill service, perform updating processing for the user interaction model by using the supplementary interaction information of the skill service. The developer himself may implement the update of the skill service without analyzing the user interaction of the skill service, thereby improving the developing efficiency and reliability of the skill service provided by the intelligent device.

In addition, according to the technical solution of the present disclosure, the supplementary interaction information of the skill service is obtained through the user interaction log based on the skill service, so that the user interaction model of the skill service may be enhanced for the reliable feedback, the user interaction model of the skill service may be supplemented for the unreliable feedback, and the reliability of the skill service provided by the intelligent device may be further improved.

In addition, according to the technical solution of the present disclosure, it is possible to, by outputting the supplementary interaction information of the skill service, actively remind the developer that the service provided by the developer further has additional interaction information to achieve more perfect service and thereby further improve the developing efficiency of the skill service provided by the intelligent device.

In addition, the technical solution according to the present disclosure may be employed to effectively improve the user experience.

It should be understood that the various forms of processes shown above may be used to reorder, add, or delete steps. For example, the steps described in the present disclosure may be performed in parallel, sequentially, or in different orders as long as the desired results of the technical solutions disclosed in the present disclosure may be achieved, which is not limited herein.

The foregoing specific embodiments/implementations do not constitute a limitation on the protection scope of the present disclosure. It should be understood by those skilled in the art that various modifications, combinations, sub-combinations and substitutions may be made according to design requirements and other factors. Any modification, equivalent replacement and improvement made within the spirit and principle of the present disclosure shall be included in the protection scope of the present disclosure,

What is claimed is:

1. A skill service updating method, comprising:
obtaining supplementary interaction information of the skill service according to a user interaction log of the skill service based on a user interaction model, wherein the user interaction model is created according to initial interaction information of the skill service provided by the developer;
outputting the supplementary interaction information of the skill service; and
performing updating processing on the user interaction model with the supplementary interaction information of the skill service, in response to an operation of the developer based on the supplementary interaction information of the skill service.

2. The method according to claim 1, wherein the obtaining supplementary interaction information of the skill service according to a user interaction log of the skill service based on a user interaction model comprises:
performing analysis processing on the user interaction log of the skill service to obtain structured data which includes a name of the skill service, request information and intent information; and
taking the structured data different from the initial interaction information of the skill service, as the supplementary interaction information of the skill service, according to the initial interaction information of the skill service.

3. The method according to claim 2, wherein the request information includes a speech recognition result of speech information provided by the user and/or text information provided by the user.

4. The method according to claim 1, wherein the performing updating processing on the user interaction model with the supplementary interaction information of the skill service comprises:
performing directly updating processing on the user interaction model with the supplementary interaction information of the skill service.

5. The method according to claim 1, wherein the performing updating processing on the user interaction model with the supplementary interaction information of the skill service comprises:
performing editing processing on the supplementary interaction information of the skill service to obtain editing interaction information of the skill service; and performing the updating processing on the user interaction model with the editing interaction information.

6. The method according to claim 1, wherein the performing updating processing on the user interaction model comprises:
generating an auxiliary interaction model of the skill service so that the user interaction model and the auxiliary interaction model are used to provide the skill service to the user.

7. The method according to claim 1, wherein the performing updating processing on the user interaction model comprises:
generating a new user interaction model so that the new user interaction model is used to provide the skill service to the user.

8. An electronic device, comprising:
at least one processor; and
a storage communicatively connected with the at least one processor; wherein,
the storage stores instructions executable by the at least one processor, and the instructions are executed by the at least one processor to enable the at least one processor to perform a skill service updating method, which comprising:
obtaining supplementary interaction information of the skill service according to a user interaction log of the skill service based on a user interaction model, wherein the user interaction model is created according to initial interaction information of the skill service provided by the developer;
outputting the supplementary interaction information of the skill service; and
performing updating processing on the user interaction model with the supplementary interaction information of the skill service, in response to an operation of the developer based on the supplementary interaction information o f the skill service.

9. The electronic device according to claim 8, wherein the obtaining supplementary interaction information of the skill service according to a user interaction log of the skill service based on a user interaction model comprises:
performing analysis processing on the user interaction log of the skill service to obtain structured data which includes a name of the skill service, request information and intent information; and
taking the structured data different from the initial interaction information of the skill service, as the supplementary interaction information of the skill service, according to the initial interaction information of the skill service.

10. The electronic device according to claim 9, wherein the request information includes a speech recognition result of speech information provided by the user and/or text information provided by the user.

11. The electronic device according to claim 8, wherein the performing updating processing on the user interaction model with the supplementary interaction information of the skill service comprises:
performing directly updating processing on the user interaction model with the supplementary interaction information of the skill service.

12. The electronic device according to claim 8, wherein the performing updating processing on the user interaction model with the supplementary interaction information of the skill service comprises:
performing editing processing on the supplementary interaction information of the skill service to obtain editing interaction information of the skill service; and performing the updating processing on the user interaction model with the editing interaction information.

13. The electronic device according to claim 8, wherein the performing updating processing on the user interaction model comprises:
generating an auxiliary interaction model of the skill service so that the user interaction model and the auxiliary interaction model are used to provide the skill service to the user.

14. The electronic device according to claim 8, wherein the performing updating processing on the user interaction model comprises:
generating a new user interaction model so that the new user interaction model is used to provide the skill service to the user.

15. A non-transitory computer-readable storage medium storing computer instructions therein, wherein the computer instructions are used to cause the computer to perform a skill service updating method, which comprising:
obtaining supplementary interaction information of the skill service according to a user interaction log of the skill service based on a user interaction model, wherein the user interaction model is created according to initial interaction information of the skill service provided by the developer;
outputting the supplementary interaction information of the skill service; and
performing updating processing on the user interaction model with the supplementary interaction information of the skill service, in response to an operation of the developer based on the supplementary interaction information of the skill service.

16. The non-transitory computer-readable storage medium according to claim 15, wherein the obtaining supplementary interaction information of the skill service according to a user interaction log of the skill service based on a user interaction model comprises:
performing analysis processing on the user interaction log of the skill service to obtain structured data Which includes a name of the skill service, request information and intent information; and
taking the structured data different from the initial interaction information of the skill service, as the supplementary interaction information of the skill service, according to the initial interaction information of the skill service.

17. The non-transitory computer-readable storage medium according to claim 16, wherein the request information includes a speech recognition result of speech information provided by the user and/or text information provided by the user.

18. The non-transitory computer-readable storage medium according to claim 15, wherein the performing updating processing on the user interaction model with the supplementary interaction information of the skill service comprises:
performing directly updating processing on the user interaction model with the supplementary interaction information of the skill service.

19. The non-transitory computer-readable storage medium according to claim 15, wherein the performing updating processing on the user interaction model with the supplementary interaction information of the skill service comprises:
performing editing processing on the supplementary interaction information of the skill service to obtain editing interaction information of the skill service; and performing the updating processing on the user interaction model with the editing interaction information.

20. The non-transitory computer-readable storage medium according to claim 15, wherein the performing updating processing on the user interaction model comprises:
generating an auxiliary interaction model of the skill service so that the user interaction model and the auxiliary interaction model are used to provide the skill service to the user, or
generating a new user interaction model so that the new user interaction model is used to provide the skill service to the user.
